(19) United States
(12) Patent Application Publication
(10) Pub. No.: US 2007/0081265 A1
(43) Pub. Date: Apr. 12, 2007

(54) Color wheel unit and fabrication method thereof

(75) Inventors: Ji-Hyung Jung, Busan (KR); Nak-Yun Sung, Suwon-si (KR); Ju-Dong Oh, Suwon-si (KR); Kye-Woong Cho, Yongin-si (KR); Yong-Wan Cho, Suwon-si (KR)

Correspondence Address: STAAS & HALSEY LLP, SUITE 700, 1201 NEW YORK AVENUE, N.W., WASHINGTON, DC, 20005, US

(73) Assignee: SAMSUNG ELECTRO-MECHANICS CO., LTD., Suwon-si (KR)

(21) Appl. No.: 11/528,320

(22) Filed: Sep. 28, 2006

(30) Foreign Application Priority Data
Oct. 10, 2005 (KR) 10-2005-0095135

(51) Int. Cl. G02B 7/00

(52) U.S. Cl. 359/892

(57) ABSTRACT

A color wheel unit and a fabrication method thereof are disclosed. The color wheel unit comprises a color wheel positioned on a light path and having RGB segments, which are rotated to be inserted in order into the light path, and a driving apparatus for providing rotational force to the color wheel, where the color wheel is secured to the driving apparatus by laser welding. This allows a simplified process for joining the color wheel to the driving apparatus.

### CROSS-REFERENCE TO RELATED APPLICATIONS

This application claims the benefit of Korean Patent Application No. 2005-0095135 filed with the Korean Intellectual Property Office on Oct. 10, 2005, the disclosure of which is incorporated herein by reference in its entirety.

### BACKGROUND

1. Technical Field

The present invention relates to a color wheel unit used in digital light processing, etc., and to a fabrication method thereof.

2. Description of the Related Art

With an image projection device using digital light processing (DLP), the mosaic phenomenon in pixels, which is a problem in regular liquid crystal display (LCD) imaging devices, is eliminated to improve the ability to reproduce original colors. Such an image projection device is thus widely used in theaters, conference rooms, and projection TV's, etc. The image projection device can be divided into a front projection device and a rear projection device according to the projection method.

The front projection device adopts the method of projecting image signals from the front, and is generally used in theaters and conference rooms, etc. On the other hand, the rear projection device adopts the method of projecting image signals from the rear of the screen. The rear projection device is commonly used in the form of projection TV's. In particular, the rear projection device is used more often than the front projection device, because of its ability to display a relatively bright image even in a bright environment.

FIG. 1 is a perspective view illustrating an image projection device.

As shown in FIG. 1, an image projection device comprises a lamp 91, a condenser lens 93 which focuses and irradiates light emitted from the lamp 91, a color wheel 95 which separates the focused white light into red (R), green (G), and blue (B) colors for illumination, a collimation lens 97 which irradiates parallel the light emitted from the color wheel 95 for each color, a digital micro-mirror panel (hereafter referred to as “DMD”) 99 which adjusts the reflection angle for each pixel of the light focused by the collimation lens 97 for each color to form a picture, and a projection lens 98 which projects the light from the DMD to a large display on a screen S.

On the DMD 99 are formed numerous micro-mirrors (not shown), which are minute in size and are associated with a pixel structure on a silicon wafer, and these micro-mirrors convert the path of the incident light on/off by individually undergoing a highly rapid tilting motion according to the digital information provided to the DMD 99 by a controller. The pixels controlled individually by the DMD 99 are magnified through a projection lens 98 so that a large display picture is formed on the screen S.

The color wheel 95, as illustrated in FIG. 1, is rotated at a high speed, whereby each of the RGB segments of the color wheel 95 is inserted into the light path in order, and the desired color changes occur periodically. Since the color changes effected by the color wheel 95 must occur very quickly to provide better picture quality, it is generally required that the color wheel 95 be joined to a driving apparatus such as a motor, etc., to be rotated at a high speed (e.g. 10,800 rpm). Thus, a very high acceleration force is applied to the joint portion of the color wheel 95 and the driving apparatus, and there is a need for firm joining between the color wheel and the driving apparatus.

A conventional method of joining a color wheel motor to a driving apparatus includes using adhesive, such as thermosetting or UV-setting adhesive. The joining method using thermosetting adhesive involves coating a primer, coating the thermosetting adhesive after a certain period of time, and thermosetting the adhesive by heat drying for a certain period of time in a drying furnace, etc. The joining method using UV-setting adhesive involves coating the UV-setting adhesive and then setting by applying UV-rays.

However, since these methods require the coating of the primer and adhesive, and heat drying at a certain temperature for a certain amount of time, the fabrication process is made complicated and the fabrication time is increased. Also, the adhesive may leak to the exterior of the color wheel to degrade the performance of the color wheel unit.

### SUMMARY

The present invention aims to provide a color wheel unit and a fabrication method thereof, which can simplify the process of joining the color wheel to the driving apparatus.

One aspect of the invention provides a color wheel unit comprising a color wheel positioned on a light path and having RGB segments, which are rotated to be inserted in order into the light path, and a driving apparatus for providing rotational force to the color wheel, where the color wheel is secured to the driving apparatus by laser welding.

The driving apparatus may include a rotor joined with the color wheel and configured to rotate, the color wheel may include an insertion portion joined with the RGB segments and having an insertion hole inserted onto the rotor, and the insertion portion may be secured to an outer perimeter of the rotor by laser welding.

The rotor may include a wheel mounting portion protruding outwards along its circumference, with the insertion portion mounted onto the wheel mounting portion. The insertion hole may be interference-fitted onto the rotor.

The weld portions created by the laser welding may be formed in a plurality with constant intervals.

The driving apparatus may be an electric motor for providing driving power to the rotor. The electric motor may comprise a sleeve joined with the rotor and configured to rotate together with the rotor, a shaft rotatably supporting the sleeve, a base securing the shaft, a magnet magnetized on the inner perimeter of the rotor, and a coil secured to the base on a position facing the magnet.

The laser welding may be YAG laser welding.

Another aspect of the invention provides a method of fabricating a color wheel unit comprising inserting a color wheel onto a rotor of a driving apparatus, temporarily securing the color wheel to the rotor, and securing the color wheel to the rotor by means of laser welding.

Inert gas may be used during the laser welding to prevent overheating and deformation of a joining area of the rotor and the color wheel. The inert gas may be argon or nitrogen.

A brushing operation may further be included for removing residue created after the laser welding. The brushing operation may remove the residue using an alcohol-based solvent and acetone or an organic solvent.

The method may further comprise drying the color wheel unit after the brushing operation. The drying may be performed by air-blowing.

Weld portions created by the laser welding may be formed in a plurality with constant intervals. The laser welding may be YAG laser welding.

The weld portions may be formed along an outer perimeter of the rotor in a designated length.

The temporary securing of the color wheel to the rotor may be to temporarily secure the rotor and the color wheel by interference-fitting or by pressing the color wheel against the driving apparatus.

Additional aspects and advantages of the present invention will be set forth in part in the description which follows, and in part will be obvious from the description, or may be learned by practice of the invention.

### BRIEF DESCRIPTION OF THE DRAWINGS

FIG. 1 is a schematic diagram representing the composition of a digital light processing device.

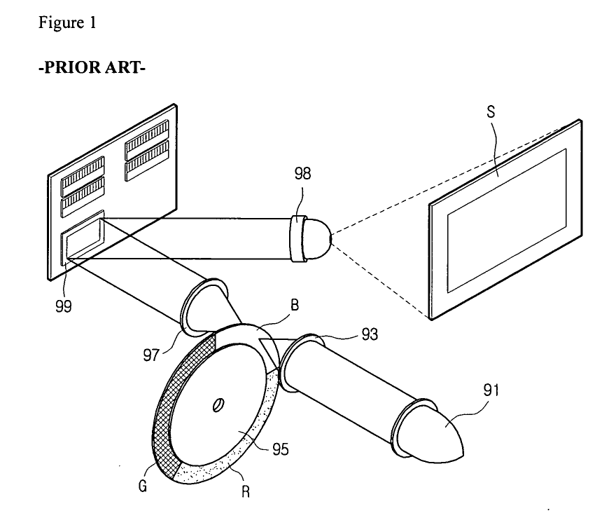

FIG. 2 is an exploded perspective view of an embodiment of a color wheel unit.

FIG. 3 is a cross-sectional view of the color wheel unit of FIG. 2 after assembly.

FIG. 4 is a plan view representing the attachment portions of the driving apparatus and color wheel in FIG. 3.

FIG. 5 is a flow diagram representing an embodiment of a method of fabricating a color wheel unit.

FIG. 6 is a cross-sectional view of a color wheel unit securing device in a color wheel unit fabrication device.

FIG. 7 is a plan view of the color wheel unit securing device in a color wheel unit fabrication device illustrated in FIG. 6.

FIG. 8 is a plan view schematically illustrating a rotary table in a color wheel unit fabricating device.

### DETAILED DESCRIPTION

Embodiments of the color wheel unit and fabrication method thereof according to the present invention will be described below in more detail with reference to the accompanying drawings. In the description with reference to the accompanying drawings, those components are rendered the same reference number that are the same or are in correspondence regardless of the figure number, and redundant explanations are omitted.

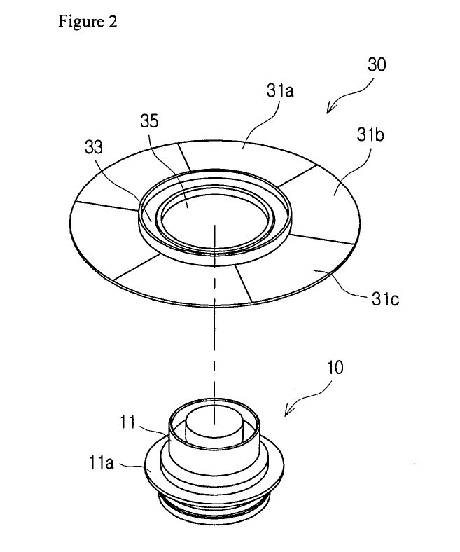

As illustrated in FIG. 2, an embodiment of a color wheel unit includes a donut-shaped color wheel 30, and a driving apparatus 10 joined with the color wheel 30 which supplies a rotational force on the color wheel 30.

The color wheel 30 is located on a light path, and includes RGB segments 31a, 31b, 31c, which are inserted into the light path in order when the color wheel is rotated by the driving apparatus, and an insertion portion 33 joined with the RGB segments.

The RGB segments comprise an R segment 31a, G segment 31b, and B segment 31c, which separate the white light emitted from a light source into red, green, and blue colors, and which are arranged in order around the circumference of the insertion portion 33.

The insertion portion 33 is inserted onto the rotor 11 of the driving apparatus to secure the color wheel 30 onto the driving apparatus, and has a ring-shape. An insertion hole 35 is formed in the center of the insertion portion 33, and the rotor 11 is inserted into this insertion hole 35. The diameters of the insertion hole 35 and the rotor 11 are substantially the same. The lower surface of the insertion portion 33 is mounted onto a wheel mounting portion 11a, which protrudes outwards from the outer perimeter of the rotor 11, and is secured to the outer perimeter of the rotor 11 by laser welding.

The driving apparatus 10 joins with the color wheel 30 to supply a rotational force to the color wheel 30. The driving apparatus 10 includes a rotor 11, to which the color wheel 30 is secured, such that it rotates together with the color wheel 30. A wheel mounting portion 11a protrudes outward along the outer perimeter of the rotor 11, and after the insertion portion 33 of the color wheel 30 is mounted onto the wheel mounting portion 11a of the color wheel 30, it is secured by laser welding.

The driving apparatus 10 may be of any form that is capable of supplying a certain rotational force to the color wheel 30. For example, an electric motor or a miniature motor, etc., may be used, where the electric motor may be a brush motor or a brushless motor, etc. Furthermore, the driving power may be supplied via a connection of gears or belts, etc., by a driving apparatus used elsewhere in the digital light processing device, instead of using a separate driving apparatus.

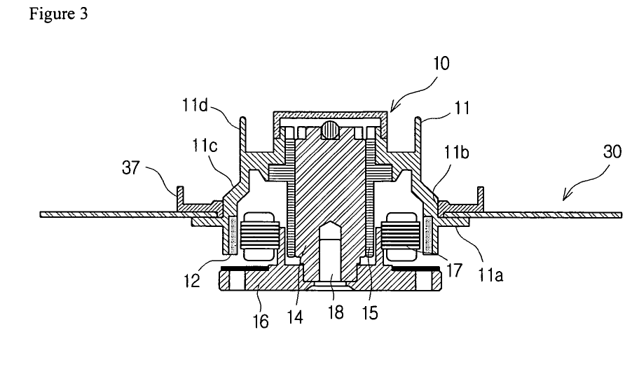

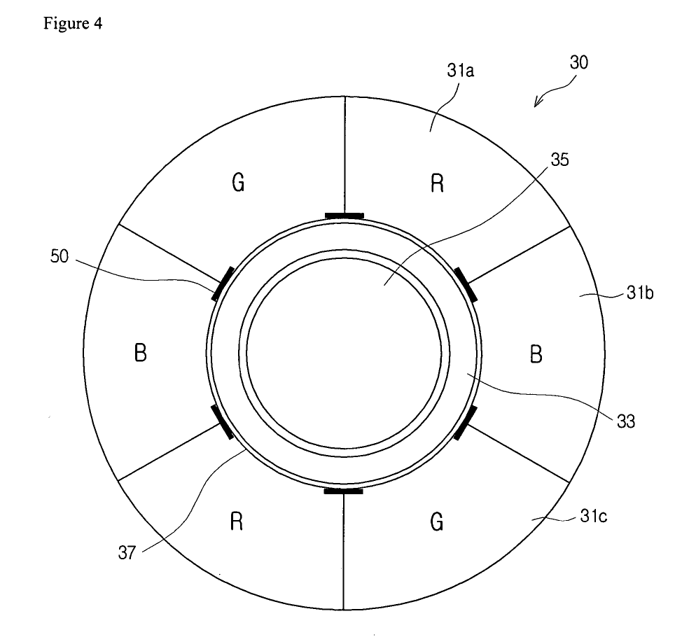

The joining of the color wheel 30 and the driving apparatus 10 will be explained below with reference to FIGS. 3 and 4.

As illustrated in FIG. 3, the color wheel 30 is mounted onto the wheel mounting portion 11a formed on the outer perimeter of the driving apparatus 10. The rotor 11 also has a first extension portion 11b protruding upwards from the wheel mounting portion 11a, an inclination portion 11c extending in a designated angle from the first extension portion 11b, and a second extension portion 11d extending upwards from the inclination portion 11c. The inner perimeter of the insertion hole 35 of the color wheel 30, as illustrated in FIG. 3, comes into contact with the first extension portion 11b and the beginning part of the inclination portion 11c. In this state, when the upper part of the inner perimeter of the insertion hole 35 and the beginning part of the inclination portion 11c are welded by laser welding, weld portions 50 are formed, as shown in FIG. 4.

Referring to FIG. 4, there are several weld portions 50 formed along the inner perimeter of the insertion portion 33 in constant intervals, each weld portion 50 having the shape of an arc with a designated central angle. The positions and number of the weld portions 50 may vary according to the size and rotation speed of the color wheel. For example, the wheel mounting portion 11a and the reverse side of the color wheel 30 may be attached together using laser welding. Also, the weld portions 50 may be in the form of points, rather than having arc shapes, or may be in the shape of a full circle.

The laser used in the laser welding may be, but is not limited to, YAG (yttrium aluminum garnet) laser, CO2 laser, or TAG (tungsten aluminum garnet) laser, etc. By securing the color wheel 30 onto the rotor of the driving apparatus using laser welding, not only may the processes be simplified, but also the fabrication time may be reduced.

The operation of the color wheel unit will now be explained below with reference to FIG. 3. In FIG. 3, an electric motor is used for the driving apparatus 10.

The driving apparatus 10 includes a rotor 11 to which the color wheel 30 is secured and which rotates together with the color wheel 30, and a shaft 14 and sleeve 15 which rotatably support the rotor 11. The sleeve 15 rotates together with the rotor 11 and is rotatably supported by the shaft 14. The shaft 14 is secured by the base 16, while a fluid bearing or ball bearings (not shown), etc., may be inserted between the shaft 14 and sleeve 15 for smoother rotation of the sleeve 15. A magnet 12 is magnetized along the inner perimeter of the rotor 11, where the magnet 12 faces a coil 17 secured to the base 16. The shaft 14 is secured to the base 16 with a screw 18.

When an electric current is supplied to the coil 17, the interaction between the electric field generated by the coil 17 and the magnetic field generated by the magnet 12 applies a driving force on the rotor 11. Thus, the rotor 11, magnet 12, and sleeve 15 rotate to supply a rotational force on the color wheel 30. The rotation speed of the rotor 11 may be adjusted by means of the amount of electric current supplied to the coil 17.

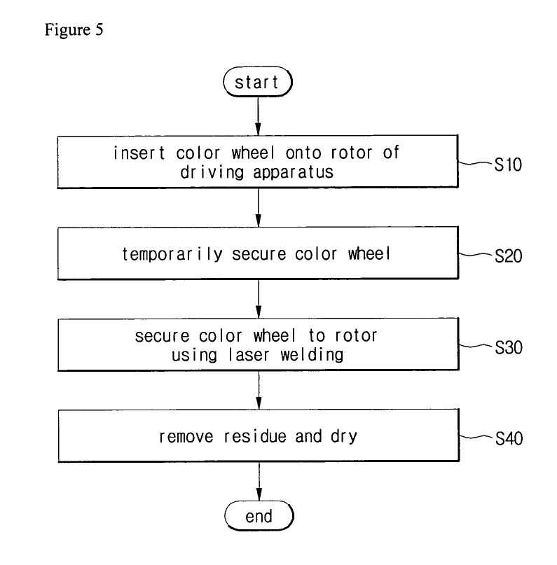

A method of fabricating the color wheel unit will now be described below with reference to FIGS. 5 to 8.

As illustrated in FIG. 5, one embodiment of a method of fabricating a color wheel unit includes inserting the color wheel 30 onto the rotor 11 of the driving apparatus 10 (operation S10), temporarily securing the color wheel 30 to the rotor (operation S20), securing the color wheel 30 to the rotor 11 using laser welding (operation S30), and removing the residue created by the laser welding such as soot, etc., and drying (operation S40).

For the operation S10 of inserting the color wheel 30 onto the rotor 11, the insertion hole 35 of the color wheel 30 is inserted onto the rotor 11 of the driving apparatus 10, after which the lower surface of the insertion portion 33 is mounted on the wheel mounting portion 11a.

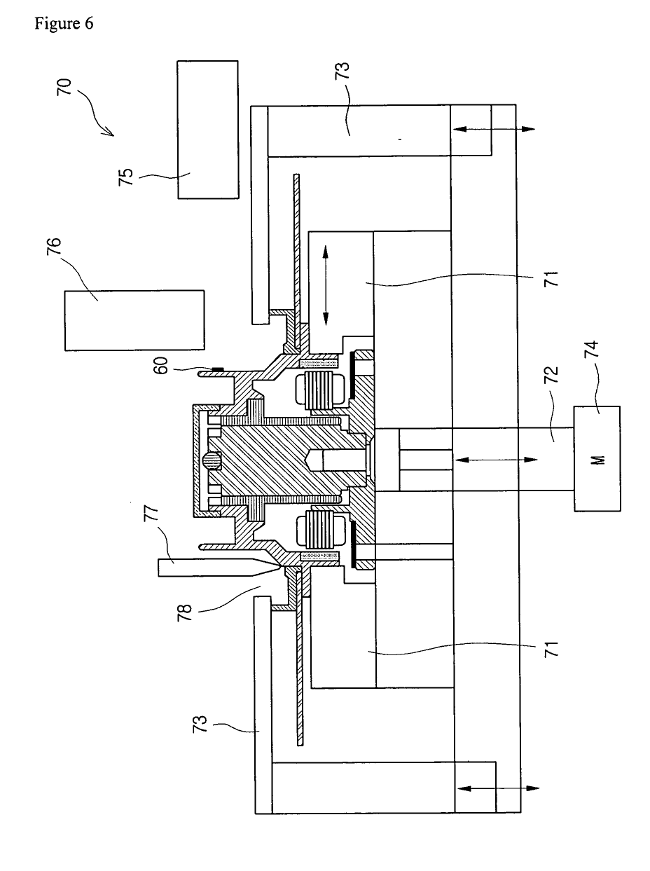

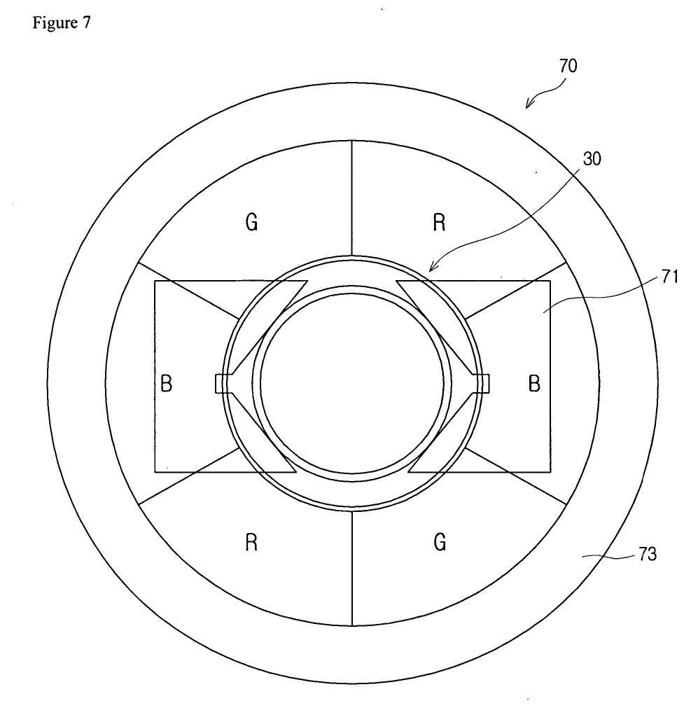

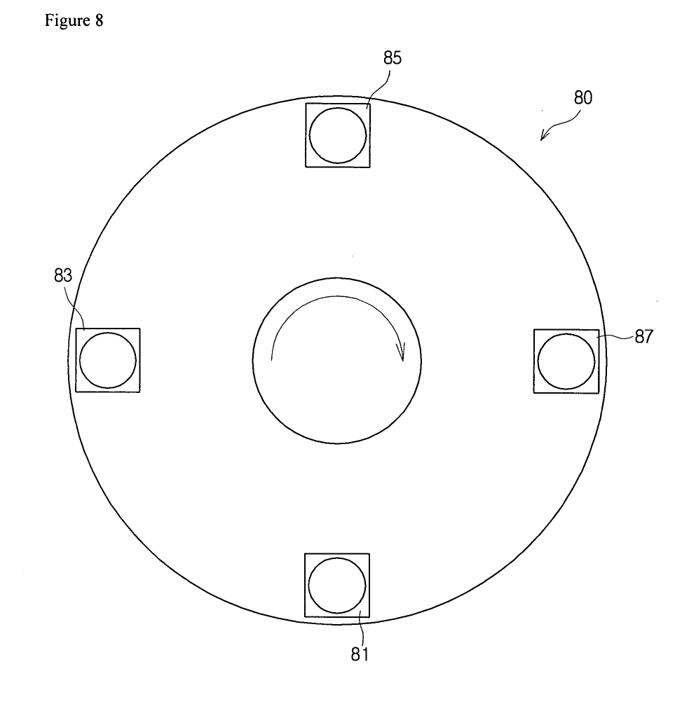

Before describing the operations S20 to S40 with reference to FIGS. 6 to 8, the securing device and rotary table used in performing the operations S20 to S40 will be described with reference to FIGS. 6 to 8. FIG. 6 is a cross-sectional view of a color wheel unit securing device for setting the position of and securing the color wheel 30, and FIG. 7 is a plan view of the color wheel unit securing device illustrated in FIG. 6. Also, FIG. 8 illustrates a rotary table 80 on which the color wheel securing device is loaded and which rotates to perform the required processes.

Referring to FIGS. 6 and 7, the color wheel securing device 70 includes side securing portions 71 having the shape of a V block. The side securing portions 71 are capable of left and right movement, and press the outer perimeter of the rotor 11 to secure the rotor 11. The color wheel securing device 70 also has a vertical securing portion 72, which regulates the vertical height of the color wheel unit. The vertical securing portion 72 moves a pin vertically through a hole in the base of the color wheel unit, so as to hold the color wheel unit, and afterwards is rotated by a motor 74 to set the position for laser welding. When the position is determined, the vertical securing portion 72 presses the wheel securing portion 73 downwards to secure the color wheel unit.

The wheel securing portion 73 presses down on the upper surface of the color wheel 30 and secures the color wheel 30. A designated space 78 is formed in the center of the wheel securing portion 73 through which the laser tip may be inserted. Also, the vertical securing portion 72 is connected to a rotary motor 74, where the rotary motor 74 adjusts the height of the vertical securing portion 72 and rotates the color wheel unit in a certain angle.

A side position recognition device 75 identifies the relative positions of the rotor 11 and the color wheel 30 joined thereto, by means of a position sensor 60 attached to the second extension portion 11d of the rotor 11. Index tape, etc., may be used for the position sensor. The vertical position recognition device 76 controls the vertical securing portion 72 such that the color wheel 30 may be pressed by the wheel securing portion 73. The laser tip 77 is secured to the upper portion of the rotary table 80, and is used to perform laser welding on the attachment portion between the color wheel 30 rotated by the rotary motor 74 and the driving apparatus 10, i.e. the through hole 35 of the color wheel 30 and the inclination portion 11c of the rotor 11.

Referring to FIG. 8, the rotary table 80 sequentially passes through a first station 81, in which the color wheel unit is loaded on or unloaded from the color wheel securing device 70, a second station 83, in which the color wheel 30 is temporarily secured to the driving apparatus 10 and afterwards secured by laser welding, a third station 85, in which a brushing process is performed for removing the residue created by the laser welding, and a fourth station 87, in which a drying process is performed.

The first to fourth stations are arranged in 90 degree angles, and are positioned on the upper or lower parts of the rotary table 80, to perform the operations S20 to S40 on the color wheel unit secured to the securing devices 70 positioned sequentially at each station.

The operations S20 to S40 will be described below with reference to FIGS. 6 to 8.

At the first station 81 of the rotary table 80, the driving apparatus 10 having the color wheel 30 inserted thereon is positioned in the securing device 70. Then, the side securing portions 71 are activated to secure the sides of the driving apparatus 10, after which the rotary table 80 is rotated so that the securing device 70 is positioned at the second station 83.

At the second station 83, the rotary motor 74 is activated to raise the color wheel unit such that the wheel securing portion 73 presses the upper surface of the color wheel 30 to secure the color wheel 30 to the driving apparatus 10 (operation S20). Then, after the side position recognition device 75 recognizes the position sensor 60 attached to the outer perimeter of the rotor 11, the position of the color wheel 30 in the vertical direction is identified using the vertical position recognition device 76, to control the position of the color wheel 30 unit in relation to the laser tip 77.

At the completion of the temporary securing of the color wheel 30 and the position setting of the laser tip 77, the laser tip 77 positioned at the second station 83 is passed through the space 78 of the wheel securing portion 73 into a position such as that shown in FIG. 6. Then, the color wheel 30 is laser welded onto the driving apparatus 10 by means of the laser tip 77, where the rotary motor 74 rotates in a minute angle to form an arc-shaped weld portion 50. Next, the rotary motor 74 rotates in a particular angle, e.g. 60 degrees, to form the weld portions 50 in the same manner (operation S30). Here, cooling may be performed using inert gas, etc., to avoid local overheating and deformations that may occur in the welded areas. Nitrogen (N2), argon (Ar), krypton (Kr), or xenon (Xe), etc., may be used for the inert gas. With the completion of the welding, the wheel securing portion 73 is moved to disengage from contact with the color wheel 30, after which the vertical securing portion 72 is moved downwards. Then, the rotary table 80 is rotated to move the securing device 70 to the third station 85.

At the third station 85, the brushing operation is performed for removing the residue formed by the laser welding. In the brushing operation to remove the residue from welding, an alcohol-based solvent and acetone or an organic solvent may be used. Afterwards, the securing device 70 which secures the color wheel unit is moved to the fourth station 87, where air blowing, etc., may be used for removing the residue left after the brushing operation and for drying.

Then, the rotary table 80 is rotated 90 degrees so that the securing device 70 is positioned again at the first station 81. The securing by the side securing portions 71 is disengaged, and the color wheel unit is detached from the securing device 70, to complete the process.

While a securing device 70 was used in the foregoing embodiment in performing the operation S20 of temporarily securing the color wheel to the rotor, in another embodiment of the method of fabricating a color wheel unit, the temporary securing may be achieved using an interference fit between the insertion hole of the color wheel and the rotor.

According to the disclosure set forth above, aspects of the present invention provide a color wheel unit and a fabrication method thereof, which can simplify the process of joining the color wheel to the driving apparatus.

While the present invention has been described with reference to particular embodiments, it is to be appreciated that various changes and modifications may be made by those skilled in the art without departing from the spirit and scope of the present invention, as defined by the appended claims and their equivalents.

What is claimed is:

1. A color wheel unit comprising:
a color wheel, positioned on a light path and having RGB segments, the RGB segments configured to be rotated and inserted in order into the light path; and
a driving apparatus for providing rotational force to the color wheel,
wherein the color wheel is secured to the driving apparatus by laser welding.

2. The color wheel unit of claim 1, wherein the driving apparatus comprises a rotor joined with the color wheel and configured to rotate,
the color wheel comprises an insertion portion joined with the RGB segments and having an insertion hole inserted onto the rotor, and
the insertion portion is secured to an outer perimeter of the rotor by laser welding.

3. The color wheel unit of claim 2, wherein the rotor comprises a wheel mounting portion protruding outwards along a circumference thereof, and the insertion portion is mounted onto the wheel mounting portion.

4. The color wheel unit of claim 2, wherein the insertion hole is interference-fitted onto the rotor.

5. The color wheel unit of claim 1, wherein weld portions created by the laser welding are formed in a plurality with constant intervals.

6. The color wheel unit of claim 1, wherein the driving apparatus is an electric motor configured to provide driving power to the rotor.

7. The color wheel unit of claim 6, wherein the electric motor comprises:
a sleeve joined with the rotor and configured to rotate together with the rotor;
a shaft rotatably supporting the sleeve;
a base securing the shaft;
a magnet magnetized on an inner perimeter of the rotor; and
a coil secured to the base on a position facing the magnet.

8. The color wheel unit of claim 1, wherein the laser welding is YAG laser welding.

9. A method of fabricating a color wheel unit, the method comprising:
inserting a color wheel onto a rotor of a driving apparatus;
temporarily securing the color wheel to the rotor; and
securing the color wheel to the rotor by means of laser welding.

10. The method of claim 9, wherein inert gas is used during the laser welding to prevent overheating and deformation of a joining area of the rotor and the color wheel.

11. The method of claim 10, wherein the inert gas is argon or nitrogen.

12. The method of claim 9, further comprising a brushing operation for removing residue created after the laser welding.

13. The method of claim 12, wherein the brushing operation comprises removing the residue using an alcohol-based solvent and acetone or an organic solvent.

14. The method of claim 12, further comprising drying the color wheel unit after the brushing operation.

15. The method of claim 14, wherein the drying is performed by air-blowing.

16. The method of claim 9, wherein weld portions created by the laser welding are formed in a plurality with constant intervals.

17. The method of claim 9, wherein the laser welding is YAG laser welding.

18. The method of claim 16, wherein the weld portions are formed along an outer perimeter of the rotor in a designated length.

19. The method of claim 9, wherein the temporary securing of the color wheel to the rotor is to temporarily secure the rotor and the color wheel by interference-fitting.

20. The method of claim 9, wherein the temporary securing of the color wheel to the rotor is by pressing the color wheel against the driving apparatus.
